(19) United States
(12) Patent Application Publication
(10) Pub. No.: US 2026/0147872 A1
(43) Pub. Date: May 28, 2026

(54) DEVICES, SYSTEMS, AND METHODS FOR PROVIDING SECURE BRANCH-FREE PASSWORD AUTHENTICATION

(71) Applicant: Tropic Square s.r.o, Prague 8 (CZ)

(72) Inventor: Andrew Richard Kozlík, Prague 8 (CZ)

(21) Appl. No.: 19/042,314

(22) Filed: Jan. 31, 2025

Related U.S. Application Data
(60) Provisional application No. 63/725,002, filed on Nov. 26, 2024.

(51) Int. Cl. G06F 21/45; H04L 9/06

(52) U.S. Cl. CPC G06F 21/45; H04L 9/0618

(57) ABSTRACT

The invention relates generally to cryptography in secure microchips using a password authentication scheme. More specifically, the invention is directed to a uniquely configured electronic hardware component and method of usage for providing secure password initialization and branch-free password authentication. The electronic hardware component together with a method of usage results in a system that, upon correctly entering a possibly low-entropy secret, such as a password, outputs a high-entropy cryptographic key while allowing only a limited number of attempts to enter the correct password. The invention effectively enforces the limit on the number of password attempts without employing a numeric counter, thus eliminating the use of conditional branching operations and making it suitable for use in secure tamper-resistant integrated circuits.

### CROSS-REFERENCE TO RELATED APPLICATIONS

This application claims priority to, and the benefit of, U.S. Provisional Application No. 63/725,002, filed Nov. 26, 2024, the content of which is incorporated by reference herein in its entirety.

### TECHNICAL FIELD

The disclosure relates generally to security of electronically stored and/or transmitted information, and, more particularly, to cryptography in secure microchips using a password authentication scheme, including a uniquely configured electronic hardware component for use in providing secure password initialization and branch-free password authentication.

### BACKGROUND

The security of digital assets is of paramount importance in a globalized digital world. Many applications protect user's assets by requiring the user to enter their password as a means of authentication before being granted access to confidential data or execution of certain functions. However, currently available client-side security solutions are often vulnerable to physical attacks.

One type of known attack is a brute-force search or attack that relies on trial and error to gain access to accounts and systems by guessing passwords, passphrases, login credentials, encryption keys, PINs (personal identification numbers) and the like. A password, passphrase, or PIN (personal identification number) is a low-entropy secret, which means that the number of possible values is sufficiently small for an attacker to be able to guess the correct value by trying to enter each possible value until one of them succeeds. As such, the attacker systematically tries every possible combination of characters or numbers until they find the correct one.

In order to protect against this type of attack, devices impose a limit on the number of incorrect password authentication attempts that they allow. This is done by means of a counter which monitors the number of incorrect password authentication attempts. Once the correct password is entered, the counter is reset to 0. However, if there are too many incorrect password authentication attempts in a row and the counter reaches the limit, then the device will block itself and no more password authentication attempts will be allowed.

In existing solutions, to determine whether an entered password is correct or not, the device typically compares the hash of the entered password with the hash of the correct password value that is stored in some form of secure memory on the device. However, these currently available solutions are susceptible to so called side-channel and fault injection attacks, which can be used to bypass these security features.

In a side-channel attack, the attacker measures the time needed by the processor to complete certain tasks or the power consumption of the microprocessor or its electromagnetic emissions while completing the task. Based on these measurements, the attacker may then deduce information about the sensitive data being processed by the microprocessor. For example, based on measuring how the processor behaves when an incorrect password is entered, the attacker may be able to deduce some information about the correct password.

In a fault injection attack, the attacker influences the intended behavior of a device by changing a critical value or changing the flow of a program e.g. to skip the incrementation of a counter or to make the device behave as if the correct password was entered, even if it was not. Faults can be injected for example by disturbing the power supply to the microprocessor (power glitching) or by exposing the chip and targeting a laser beam at specific points (laser fault injection).

There are a number of well-known countermeasures that can be used to improve resistance to fault injection and side-channel attacks. For example, when verifying an entered password, a program should first increment the password attempt counter, then compare (in constant time) the entered password against the stored correct password and, if the entered password is correct, then reset the password attempt counter to 0. The critical part of this countermeasure is that the counter is incremented before verifying the password. For instance, if the counter is incremented after verifying the password, then an attacker could cut the power to the device after the password was checked and found to be invalid, but before the device had time to increment the counter, which would allow the attacker unlimited password authentication attempts. However, most of these countermeasures do not eliminate the weaknesses that make the algorithm susceptible to fault injection, as they only patch the weaknesses to make them more difficult to exploit, for example, by introducing random length delays around sensitive code to make it more difficult for an attacker to target the sensitive operation.

As such, there are at least two key features of existing technical solutions that are susceptible to fault injection attacks, which include numeric counter features and conditional branching operations. Regarding a numeric counter, as previously described, an attacker may use fault injection to reset the numeric counter, even though the correct password was not entered and the counter should not have been reset, or to bypass the incrementation of the counter when it should be incremented.

Furthermore, existing solutions are based on conditional branching operations, also known as conditional statements or conditional jumps, which are programming constructs that allow a program to make decisions and execute different code paths based on certain conditions. A conditional branching operation determines the flow of a program based on some condition. These operations provide the ability to alter the flow of execution based on the evaluation of a logical condition. For example, a device which outputs a secret decryption key when the correct password is entered may implement the following branching operations: 1) if the password attempt counter is less than 3, then allow the user to enter the password, otherwise show error; and 2) if the entered password is correct, then reset the password attempt counter to zero and output the secret decryption key, otherwise increment the counter and ask the user to try entering the password again. Fault injection can be used, for example, to make the device output the secret decryption key when the entered password was not actually correct, or it can be used to bypass the incrementation of the counter or the check that the password attempt counter is less than 3, which would allow the attacker unlimited password authentication attempts.

### SUMMARY

The invention of the present disclosure addresses the drawbacks and limitations of existing security solutions by providing improved resilience to physical attacks. In particular, the invention essentially solves the problems facing secure password authentication techniques and the concept of limiting the number of allowed authentication attempts by essentially eliminating at least the numeric counter features and conditional branching operations of known technical solutions.

More specifically, the invention is directed to a uniquely configured electronic hardware component and method of usage for providing secure password initialization and branch-free password authentication. For example, the electronic hardware component together with the method of usage results in a system that, upon correctly entering a possibly low-entropy secret, such as a password, outputs a high-entropy cryptographic key while allowing only a limited number of attempts to enter the correct password, wherein the key is used to access (e.g., decrypt) whatever data is protected by the password.

A high-entropy cryptographic key is a key that contains a large amount of randomness. The larger the key space (the total number of possible keys), the more computationally infeasible it becomes to guess the correct key through brute force. A Message Authentication Code (MAC) function is a cryptographic algorithm that generates a fixed-size output, known as a MAC or authentication tag, based on a message and a secret key. The MAC usually serves as a fingerprint or a signature for the message, allowing the recipient to verify its integrity and authenticity. For a MAC function, it should be computationally infeasible to compute a valid MAC of a given message without knowledge of the key, even if the adversary knows the MAC of any message but the one in question. This property makes a MAC function a suitable building block for implementing the present invention.

MAC-and-destroy is a concrete instance of the invention, in which it is an operation during which secret data are processed, erased and replaced by a set of newly stored data that are used for the next computing operation. The MAC function of the MAC-and-destroy concept can be replaced by another cryptographic primitive, such as a hash function or cipher, but the overall principle of secret data deletion before verification is preserved.

Accordingly, the invention effectively enforces the limit on the number of password attempts without employing a numeric counter, thus eliminating the use of conditional branching operations and making it suitable for use in secure tamper-resistant integrated circuits. As such, the present invention is different from traditional implementations of authentication mechanisms which rely on securely executing a series of potentially bypassable steps and conditional branching operations (in which an attacker could force traditional hardware to skip a critical step or to force a change in the state of the hardware so that a different execution path is taken). Rather, the present invention provides a mechanism that does not involve conditional branching and requires all steps to be executed correctly, such that attempting to bypass or tamper with any of the steps will cause the high-entropy secret to be computed incorrectly.

In one aspect, the present invention is directed to an electronic hardware component for use in providing secure password initialization and branch-free password authentication. The electronic hardware component includes one or more deterministic finite state transducers (i.e., a single transducer or multiple transducers). Each deterministic finite state transducer includes: 1) a secret internal state, wherein the number of possible secret internal states is sufficiently large and infeasible to enumerate; 2) a means to configure the secret internal state to a state that is either reproducible by a configuring entity or to a state that is, or will become, known to a configuring entity; and 3) a transition function, wherein inputs for said transition function include both an externally provided input value and the internal state. The transition function is implemented in response to a password authentication attempt, wherein said externally provided input is associated with a password. Implementation of the transition function comprises processing of the externally provided input value and the internal state to thereby transition said transducer into a new internal state and produce an output value in such a way that it is infeasible for an unauthorized entity to compute the input internal state by choosing a suitable externally provided input value and observing the produced output value.

The implementation of the transition function is devoid of use of a numeric counter for limiting the number of password authentication attempts.

The electronic hardware component is configured to be implemented in a secure tamper-resistant integrated circuit and/or within a password-protected device and operably coupled to a processor associated with the password-protected device. The password-protected device may include, but is not limited to, personal computing device (e.g., a mobile phone or the like), any form of security token (e.g., a hardware wallet), and any other password-protected device in which the security of electronically stored and/or transmitted information is desired. The processor is operably coupled to memory containing instructions executable by the processor to cause the electronic hardware component to function in response to receipt of input associated with initialization and/or authentication of a password.

The transition function may be implemented by means of running an algorithm selected from the group consisting of a cipher algorithm, a message authentication code (MAC) algorithm, a hash algorithm, and a customized cryptographic algorithm. For example, implementing the transition function comprises running a block cipher algorithm or running a stream cipher algorithm.

The transition function may include the execution of a function whose inputs include an externally provided input value and said secret internal state, and transitions said transducer into said new internal state and a function whose inputs include said new internal state, and produces said output value.

In some embodiments, upon receipt of a correct password, and thus a successful password attempt, the produced output value is an associated desired secret. In some embodiments, the desired secret is associated with a private key for use in asymmetric cryptography. In some embodiments, the transition function can be expressed in such a way that the new internal state depends only on the previous internal state of the transducer, and it is infeasible to return the transducer to an earlier internal state by repeatedly invoking the transition function.

In some embodiments, the electronic hardware component is configured as a single deterministic finite state transducer.

In other embodiments, the electronic hardware component is configured as a plurality of deterministic finite state transducers, wherein a threshold maximum limit on the allowed number of password authentication attempts is directly tied to a number of deterministic finite state transducers available. In some embodiments, each of the plurality of deterministic finite state transducers is configured to the same initial secret internal state. In some embodiments, for a given password authentication attempt, a corresponding one of the plurality of deterministic finite state transducers implements a transition function, and, upon receipt of an incorrect password, the previous secret internal state of the corresponding one of the plurality of deterministic finite state transducers is overwritten with a new internal state and a different one of the plurality of deterministic finite state transducers implements a transition function for a subsequent password authentication attempt. It should be noted that, for any given password authentication attempt, the previous secret internal state of a given one of the deterministic finite state transducers is overwritten regardless of whether a correct or an incorrect password is received.

The desired secret may be associated with a cryptographic key. For example, in some embodiments, the output value may be associated with a cryptographic key that is processable via a decryption function. In such an embodiment, at least one of data protected by the password and said secret internal state is encrypted.

Accordingly, in one embodiment, data protected by the password may be encrypted using an authenticated cipher with a high-entropy key, said high-entropy key being the cryptographic key or the output value, such that a decryption function attempting to decrypt the ciphertext and authentication tag using the output value can be performed, wherein: if the decryption attempt is successful, the password is deemed correct and the data protected by the password is outputted in plaintext; and if the decryption attempt is unsuccessful, the password is deemed incorrect and a notification is outputted indicating that the password is incorrect.

In another embodiment, said secret internal state is encrypted using an authenticated cipher with a high-entropy key, said high-entropy key being the cryptographic key or the output value, such that a decryption function attempting to decrypt the ciphertext and authentication tag using the output value can be performed, wherein: if the decryption attempt is successful, the password is deemed correct and the high-entropy key is outputted to be used for accessing data protected by the password; and if the decryption attempt is unsuccessful, the password is deemed incorrect and a notification is outputted indicating that the password is incorrect. In some embodiments, a threshold maximum limit on the allowed number of password authentication attempts is directly tied to the number of ciphertexts and, for a given password authentication attempt, a corresponding one of the plurality of ciphertexts is attempted to be decrypted.

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a block diagram illustrating an exemplary implementation of a finite state transducer consistent with the present disclosure.

FIG. 2 is a block diagram illustrating an exemplary password initialization method consistent with the present disclosure.

FIG. 3 is a block diagram illustrating an exemplary password authentication method consistent with the present disclosure.

FIG. 4 is a block diagram illustrating an exemplary password initialization method associated with a single-transducer scheme, consistent with the present disclosure.

FIG. 5 is a block diagram illustrating an exemplary password authentication method associated with a single-transducer scheme, consistent with the present disclosure.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

By way of overview, the present invention relates to cryptography in secure microchips using a password authentication scheme. More specifically, a hardware element (transducer) is used to implement a secure mechanism for the conversion of a low-entropy secret, such as a password, to a high-entropy secret, such as a cryptographic key, while allowing only a limited number of attempts at guessing the correct password. The limit is enforced through branchless operations that do not involve the use of a counter.

Accordingly, the present invention provides improved resilience to physical attacks over existing security solutions and countermeasures. In particular, the invention essentially solves the problems facing secure password authentication techniques and the concept of limiting the number of allowed authentication attempts by essentially eliminating at least the numeric counter features and conditional branching operations of known technical solutions.

As such, the present invention is different from traditional implementations of authentication mechanisms which rely on securely executing a series of potentially bypassable steps and conditional branching operations (in which an attacker could force traditional hardware to skip a critical step or to force a change in the state of the hardware so that a different execution path is taken). Rather, the present invention provides a mechanism that does not involve conditional branching and requires all steps to be executed correctly, such that attempting to bypass or tamper with any of the steps will cause the high-entropy secret to be computed incorrectly. Accordingly, the present invention takes a new and unintuitive approach to addressing the drawbacks and limitations of existing security solutions by eliminating the numeric counter and the conditional branching operations, which is present in existing password-based authentication solutions and which may be the target of fault injection attacks.

It should be noted that the present invention can be applied in all areas of electronics where user authentication is required and aims at covering a number of industries, from securing storage in hardware devices to securing communications and online identity verification.

The present invention is configured to be used for securing storage and user authentication in secure tamper-resistant integrated circuits, also known as secure elements or secure cryptoprocessors. Such secure tamper-resistant integrated circuits may be utilized for various purposes, including, but not limited to: smart cards, e.g. SIM cards, payment cards or national identity cards; trusted platform modules; mobile phones, tablets and personal computers in general; hardware-based authenticators, also known as security tokens, hardware tokens or security keys; cryptocurrency hardware wallets; and hardware security modules, to name a few.

### Hardware Component

The invention consists of a process that is tied to read-protected memory that necessitates hardware support. As such, a fundamental building block of the scheme is a hardware component that implements a deterministic finite state transducer T, which allows configuring the initial internal state. The internal state of the transducer is stored in read-protected memory.

In order to achieve the desired security goal, T should satisfy one or more of the following properties:
1. The number of possible initial internal states of T must be sufficiently large so that they are infeasible to enumerate;
2. For an attacker that may observe and interact with T it should be computationally and physically infeasible to determine full or partial information about the internal state S of T at the moment in time when the attacker's observation and interaction commenced; and
3. T should implement a function that is secure in terms of indistinguishability. To be specific, consider an adversary who was given the opportunity to query multiple copies of T that are all initially in the same state S, i.e. to observe the outputs of T on a number of inputs of the attacker's choice. If the adversary then selects a two element set of inputs that it had not submitted as the first query to any copy of T, then given the output of T in state S for a randomly chosen input from the two-element input set it should be computationally infeasible for the adversary to identify the input choice with probability significantly better than that of random guessing.
   A concrete implementation of T may have the following form:
1. The internal state of T is an n-bit value, n≥128.
2. T accepts n-bit values as input and returns n-bit values as output.
3. T implements a transition function ƒ in such a way that when T is in state S, then upon input x it will output ƒ(S, x) and transition from state S to state x.
   Examples of the transition function ƒ(S, x) include, but are not limited to:
A block cipher, such as AES, where S is used as the key and x is the plaintext.
A stream cipher, where S is used as the key, x is the IV or nonce and the output is the first n bits of the keystream.
A MAC function where S is used as the key and x is the message.
A cryptographic hash function h so that ƒ(S, x)=h(S∥x), where “∥” denotes concatenation.

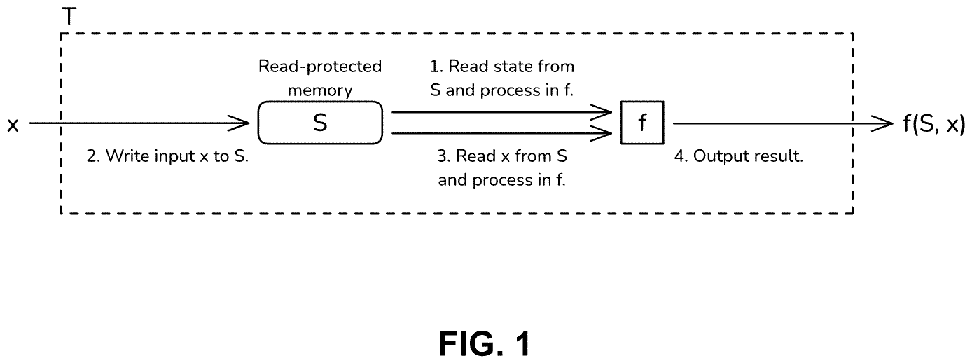

FIG. 1 is a block diagram illustrating an exemplary implementation of a finite state transducer consistent with the present disclosure. FIG. 1 provides an example of an implementation of the finite state transducer T described above. Upon executing steps 1 through 4, the transducer transitions from the previous internal state S to state x and outputs ƒ(S, x).

A high-entropy cryptographic key is a key that contains a large amount of randomness. The larger the key space (the total number of possible keys), the more computationally infeasible it becomes to guess the correct key through brute force. A Message Authentication Code (MAC) function is a cryptographic algorithm that generates a fixed-size output, known as a MAC or authentication tag, based on a message and a secret key. The MAC usually serves as a fingerprint or a signature for the message, allowing the recipient to verify its integrity and authenticity. For a MAC function, it should be computationally infeasible to compute a valid MAC of a given message without knowledge of the key, even if the adversary knows the MAC of any message but the one in question. This property makes a MAC function a suitable building block for implementing the present invention.

MAC-and-destroy is a concrete instance of the invention, in which it is an operation during which secret data are processed, erased and replaced by a set of newly stored data that are used for the next computing operation. The MAC function of the MAC-and-destroy concept can be replaced by another cryptographic primitive, such as a hash function or cipher, but the overall principle of secret data deletion before verification is preserved.

Accordingly, one of the key physical features of the invention is the set of m transducers, where m is the number of allowed password authentication attempts. These transducers would typically be implemented as m read-protected memory units each storing the internal state of the corresponding transducer. Read access to these memory units would be restricted to the transition function.

In terms of the way in which the transducers are used for the stated purpose, the key features of the invention are:
The input to the transducer is derived from the password value.
The output of the transducer is used to derive the secret key.
   In terms of the properties of the transducer, the key features are:
The transducer allows some way to configure the secret internal state to a state that is either reproducible by a configuring entity or to a state that is, or will become, known to a configuring entity, see “Possible variations of the scheme” section for details.
The transducer can effectively be used only once to obtain the secret key from the correct password. When an incorrect password is provided it is computationally infeasible to obtain any useful information about the secret key from the transducer's output or from further interaction with the transducer in its new state even if the correct password becomes known.

### The Scheme

Let m be the desired password attempt limit. The scheme consists of m transducers T₁, . . . , Tₘ. The input to a transducer T is the password or a value that is deterministically derived from the password. Denote this derived value by x. The password may for example be combined with other secret or public data to derive x, but in the simplest case, where no other data is added, x can simply be the password value padded to n bits or a hash of the password.

### Initialization Method

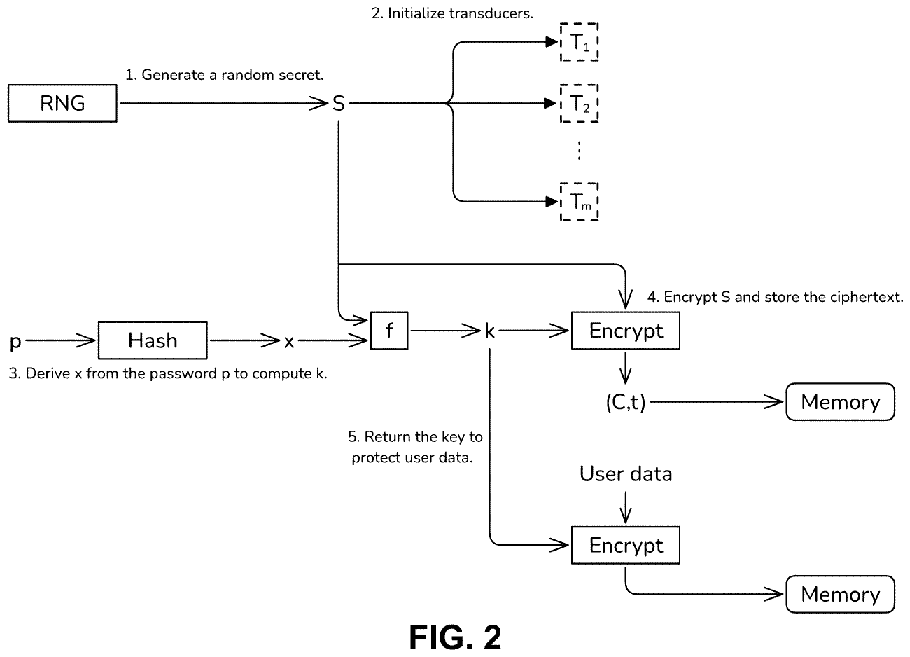

FIG. 2 is a block diagram illustrating an exemplary password initialization method consistent with the present disclosure, making use of the finite state transducer as previously described herein.

To set up a new password p the controlling entity takes the following steps:
1. Generate a random n-bit secret S.
2. Configure each of the m transducers to the same initial state S.
3. Derive x using p and determine k=ƒ(S, x), where ƒ is the transition function of T.
4. Encrypt S using an authenticated cipher with k as the key and store the resulting ciphertext and authentication tag (C, t) in memory.
5. Return the high-entropy key k.

### Password Authentication Method

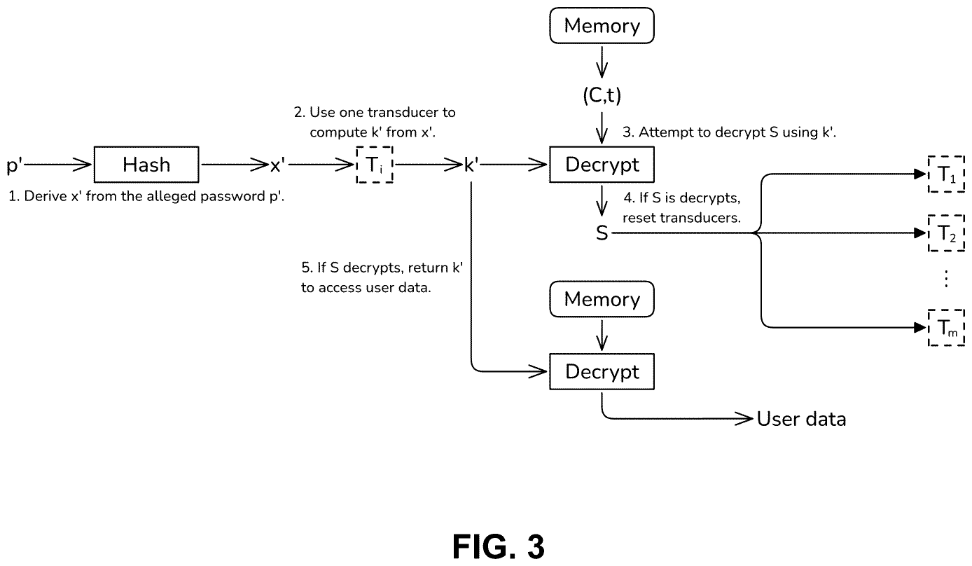

FIG. 3 is a block diagram illustrating an exemplary password authentication method consistent with the present disclosure, making use of the finite state transducer previously described herein.
1. For i in {1, . . . , m}:
   1.1. Request the password p′ from the user and derive x′ from p′.
   1.2. Obtain the output k′ of Tᵢ upon input x′.
   1.3. Attempt to decrypt (C, t) using k′ to obtain S.
   1.4. If decryption succeeds, then:
      1.4.1. Configure each of the used transducers T₁, . . . , Tᵢ to the initial state S, thereby resetting the number of available password authentication attempts to m.
      1.4.2. Return the high-entropy key k′, which is equal to k.
2. Return FAIL (“Exceeded the number of password authentication attempts”).

### Possible Variations of the Scheme

In the password authentication algorithm the transducers do not need to be used in a fixed order T₁, . . . , Tₘ. A different order of use can be prescribed after every successful password authentication so as to improve wear-leveling.

In the scheme previously described herein, an authenticated cipher is used to determine whether k′ is the correct key k, i.e. whether the correct password was provided. However, any other kind of integrity check that does not reveal information about k may be used in its place. For example a preimage-resistant hash function h may be used in such a way that t=h(k) is stored in memory and the correctness of the provided password is then determined by verifying that h(k′)=t.

In the scheme previously described herein, the output of T is used directly as the high-entropy key, but it should be noted that the output may instead be further processed and possibly combined with other secret or public data to derive one or more high-entropy keys for various purposes.

The key k, or the data derived from it, need not be used for encryption, but may be used for other cryptographic purposes. For example, it can be used as the private key in asymmetric cryptography, such as a signature scheme, in which case determining whether the correct password was provided can be done by computing the public key from the obtained private key and verifying that it matches the expected public key.

The scheme previously described herein stores the original initial state S encrypted using k, which is convenient when resetting the number of available password authentication attempts in order to minimize the number of memory writing operations. Instead of storing S encrypted using k, an alternative is to generate a new value of S when resetting the number of available password authentication attempts every time the password is correctly entered. However, this is less convenient since it results in k changing after every correct password authentication, which typically requires re-encrypting the protected data using the new key.

The transducers do not necessarily have to be all initialized to the same state and they do not necessarily need to implement the same transition function. If different initial states S₁, . . . , Sₘ are used or different transition functions are used, then each of them will result in a different key k₁, . . . , kₘ, which is generally an inconvenience, because the protected data then needs to be encrypted m times, i.e. once using each of the different keys. However, this may be useful if the password authentication attempts are to be differentiated from each other. For example it could be used to introduce a rate-limiting mechanism which enforces exponential backoff between individual password authentication attempts as follows. During initialization for each i=1, . . . , m compute kᵢ=ƒᵢ(Sᵢ, x), replace the i least significant bits of kᵢ with random values and encrypt the i-th copy of the protected data using this modified key. During the i-th attempt at password verification the device will need to determine the i least significant bits of the key by trying to decrypt the i-th copy of the protected data using all possible values for the i least significant bits of the decryption key. The expected number of decryption attempts needed grows exponentially in i, thus the time needed to verify the password grows exponentially with each incorrect password authentication attempt.

The transducer needs to allow some way of configuring the initial internal state. In the simplest case this means being able to configure the transducer to an arbitrary internal state of the controlling entity's choice, the controlling entity being usually the corresponding firmware. However, it is sufficient for the transducer to only allow configuring to a state that will become known to the controlling entity or to only allow configuring to a reproducible, possibly unknown, state so that two or more transducers can be configured into an identical state. The scheme can be easily adjusted to work with any of these types of transducers.

It should be noted that the possible variations of their implementation are innumerable. To give a few alternative examples of their implementation, let ƒ be a function such as one of the transition functions given above. Then, for example:
Assume that T can be reset to an arbitrary internal state of the controlling entity's choice. When T is in state S, then upon input x it will output ƒ(S, x) and transition from state S to the null state.
Assume that T can be reset to some fixed state, the value of which is unknown to the controlling entity. When T is in state S, then upon input x it will transition from state S to ƒ(S, x) and output the new state.

It should be noted that the initialization method and password authentication methods would need to be adjusted accordingly for these alternative transducers.

### Single Transducer Variation of the Scheme

There also exists a variation of the scheme that requires only a single transducer to accommodate multiple password attempts. This scheme can be implemented with a transducer whose transition function can be expressed in such a way that the new internal state depends only on the previous internal state of the transducer, not the input.

Assume that T can be reset to an arbitrary internal state of the controlling entity's choice. When T is in state S, then upon input x it will output ƒ(S, x) and transition from state S to g(S). The function ƒ should be chosen to be secure in terms of indistinguishability, as discussed above. The function g should be chosen so that given an arbitrary admissible state S₀, it is infeasible to enumerate a sequence of iterated function values Sᵢ=g(Sᵢ−1), i=1, 2, . . . , such that S₀ recurs in he sequence. An example of such a function is g(S)=S+1 mod 2ⁿ, where the state is interpreted as an integer and we assume that the number of states, 2ⁿ, is infeasible to enumerate. Another example of a suitable function g is a maximum-length linear feedback shift register (LFSR), with the null state not being considered an admissible initial state of the transducer. Initializing an LFSR with the null state results in a constant sequence of iterated values, all null. Initializing a maximum-length LFSR with any state other than the null state results in a sequence of period 2ⁿ−1, which is infeasible to enumerate, as required. As a result of this property, it is infeasible to return the transducer to an earlier internal state by repeatedly invoking the transition function.

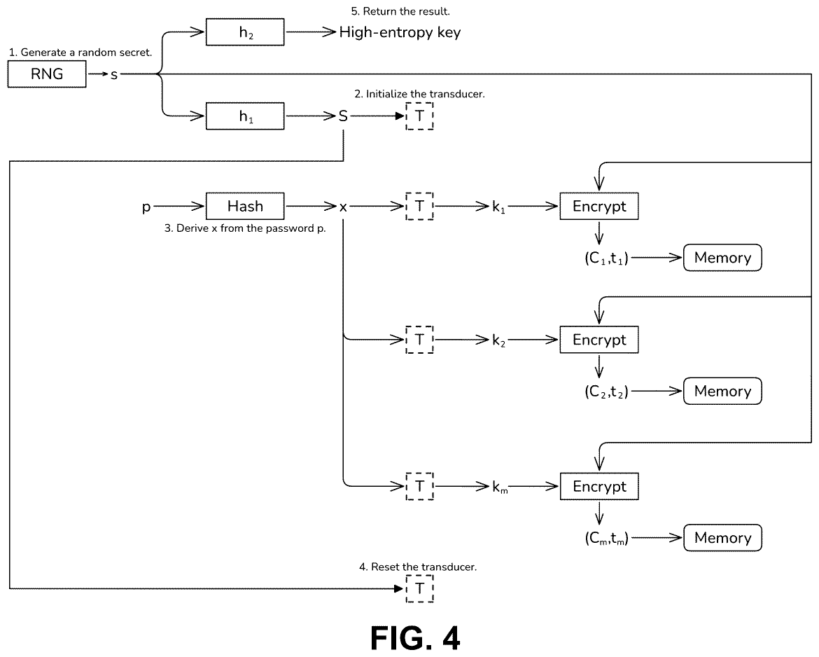

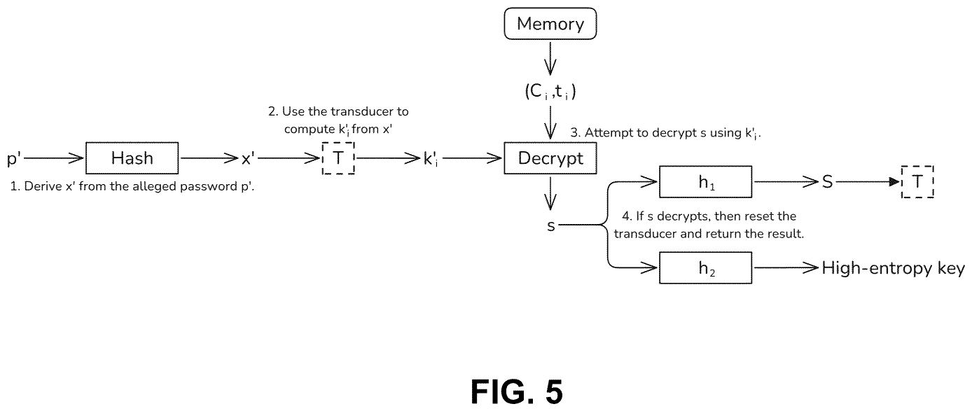

FIG. 4 is a block diagram illustrating an exemplary password initialization method associated with a single-transducer scheme and FIG. 5 is a block diagram illustrating an exemplary password authentication method associated with a single-transducer scheme, consistent with the present disclosure.

### Initialization Method

Let h₁ and h₂ be independent one-way functions. To set up a new password p with a maximum of m authentication attempts, the controlling entity takes the following steps:
1. Generate a random n-bit secret s.
2. Compute S=h₁(s) and configure the transducer to the initial state S.
3. Derive x using p and for i in {1, . . . , m}:
   3.1. Obtain the output kᵢ of the transducer upon input x.
   3.2. Encrypt s using an authenticated cipher with kᵢ as the key and store the resulting ciphertext and authentication tag (Cᵢ, tᵢ) in memory.
4. Configure the transducer to the initial state S.
5. Compute h₂(s) and return the result as the high-entropy key.

### Password Authentication Method

1. For i in {1, . . . , m}:
   1.1. Request the password p′ from the user and derive x′ from p′.
   1.2. Obtain the output kᵢ′ of the transducer upon input x′.
   1.3. Attempt to decrypt (Cᵢ, tᵢ) using kᵢ′ to obtain s.
   1.4. If decryption succeeds, then:
      1.4.1. Compute S=h₁(s) and configure the transducer to the initial state S.
      1.4.2. Compute h₂(s) and return the result as the high-entropy key.
2. Return FAIL (“Exceeded the number of password authentication attempts”).

A potential disadvantage of using a transition function where the new internal state depends only on the previous internal state of the transducer is that the hardware implementation may be more susceptible to fault injection attacks than the multi-transducer scheme described earlier. An attacker may be able to use fault injection to bypass the state transition, i.e. bypass the update of the internal state from S to g(S), while still producing the output correctly, which would allow the attacker unlimited password authentication attempts. In addition to hardware countermeasures, a design countermeasure can be introduced to ensure that the state has been correctly updated before producing the output. The output of the transducer can be defined to be ƒ(S∥S′, x), where S is the previously stored internal state of the transducer and S′ is the newly stored internal state, i.e. S′=g(S). This ensures that the output is not computed correctly until the internal state has been updated correctly.

### Possible Variations of the Single Transducer Scheme

A majority of the variations of the multi-transducer scheme described earlier can be applied to the single transducer scheme. Namely the authenticated cipher can be replaced with any kind of integrity check to determine whether the correct password was provided, a rate-limiting mechanism which enforces exponential backoff can be implemented similarly as already described, and the scheme can be easily adjusted to be used with a transducer that only allows configuring the initial internal state to a state that will become known to the controlling entity or that only allows configuring to a reproducible, possibly unknown, state.

Functions h₁ and h₂ need not necessarily be one-way functions, however this property is advisable for security reasons, depending on the particulars of ƒ and how the resulting high-entropy key is used. Furthermore, S may be generated as a random secret independently of s and stored encrypted, or not stored at all and generated anew every time when resetting the number of available password authentication attempts.

### Terms and Expressions

As used in any embodiment herein, the term “module” may refer to software, firmware and/or circuitry configured to perform any of the aforementioned operations. “Software” may be embodied as a software package, code, instructions, instruction sets and/or data recorded on non-transitory computer readable storage medium. “Firmware” may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

Any references and citations to other documents, such as patents, patent applications, patent publications, journals, books, papers, web contents, that have been made throughout this disclosure are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. An electronic hardware component for use in providing secure password initialization and branch-free password authentication, the electronic hardware component comprising one or more deterministic finite state transducers, each transducer comprising:
a secret internal state, wherein the number of possible secret internal states is sufficiently large and infeasible to enumerate;
a means to configure the secret internal state to a state that is either reproducible by a configuring entity or to a state that is, or will become, known to a configuring entity; and
a transition function, wherein inputs for said transition function comprise: 1) an externally provided input value; and 2) the internal state,
wherein said transition function is implemented in response to a password authentication attempt, wherein said externally provided input is associated with a password,
wherein implementation of said transition function comprises processing of the externally provided input value and the internal state to thereby transition said transducer into a new internal state and produce an output value in such a way that it is infeasible for an unauthorized entity to compute the input internal state by choosing a suitable externally provided input value and observing the produced output value, and
wherein a limit on the number of password authentication attempts is imposed without use of a numeric counter.

2. The electronic hardware component of claim 1, wherein said transition function is implemented by means of running an algorithm selected from the group consisting of a cipher algorithm, a message authentication code (MAC) algorithm, a hash algorithm, and a customized cryptographic algorithm.

3. The electronic hardware component of claim 2, wherein implementing the transition function comprises running a block cipher algorithm.

4. The electronic hardware component of claim 2, wherein implementing the transition function comprises running a stream cipher algorithm.

5. The electronic hardware component of claim 1, wherein said transition function comprises the execution of:
a function whose inputs include an externally provided input value and said secret internal state, and transitions said transducer into said new internal state; and
a function whose inputs include said new internal state, and produces said output value.

6. The electronic hardware component of claim 1, wherein, upon receipt of a correct password, and thus a successful password attempt, the produced output value is an associated desired secret.

7. The electronic hardware component of claim 6, wherein said transition function can be expressed in such a way that the new internal state depends only on the previous internal state of the transducer, and it is infeasible to return the transducer to an earlier internal state by repeatedly invoking the transition function.

8. The electronic hardware component of claim 7, wherein the electronic hardware component is configured as a single deterministic finite state transducer.

9. The electronic hardware component of claim 1, wherein the electronic hardware component is configured as a plurality of deterministic finite state transducers, and wherein a threshold maximum limit on the allowed number of password authentication attempts is directly tied to a number of deterministic finite state transducers available.

10. The electronic hardware component of claim 9, wherein each of the plurality of deterministic finite state transducers is configured to the same initial secret internal state.

11. The electronic hardware component of claim 9, wherein, for a given password authentication attempt, a corresponding one of the plurality of deterministic finite state transducers implements a transition function.

12. The electronic hardware component of claim 11, wherein, upon receipt of an incorrect password, the previous secret internal state of the corresponding one of the plurality of deterministic finite state transducers is overwritten with a new internal state and a different one of the plurality of deterministic finite state transducers implements a transition function for a subsequent password authentication attempt.

13. The electronic hardware component of claim 6, wherein the desired secret is associated with a cryptographic key.

14. The electronic hardware component of claim 13, wherein the output value is associated with a cryptographic key that is processable via a decryption function.

15. The electronic hardware component of claim 14, wherein at least one of: 1) data protected by the password; and 2) data associated with said secret internal state is encrypted with a high-entropy key, said high-entropy key being the cryptographic key or the desired secret.

16. The electronic hardware component of claim 15, wherein at least one of: 1) data protected by the password; and 2) data associated with said secret internal state are encrypted using an authenticated cipher, such that a decryption function attempting to decrypt the ciphertext and authentication tag using the output value can be performed, wherein:
if the decryption attempt is successful, the password is deemed correct and at least one of: 1) the decrypted plaintext data; and 2) the high-entropy key is outputted; and
if the decryption attempt is unsuccessful, the password is deemed incorrect and a notification is outputted indicating that the password is incorrect.

17. The electronic hardware component of claim 16, wherein a threshold maximum limit on the allowed number of password authentication attempts is directly tied to the number of ciphertexts.

18. The electronic hardware component of claim 17, wherein, for a given password authentication attempt, a corresponding one of the plurality of ciphertexts is attempted to be decrypted.

19. The electronic hardware component of claim 13, wherein the desired secret is associated with a private key for use in asymmetric cryptography.

20. The electronic hardware component of claim 1, wherein the electronic hardware component is configured to be implemented in a secure tamper-resistant integrated circuit.

21. The electronic hardware component of claim 1, wherein the electronic hardware component is configured to be implemented in a password-protected device and operably coupled to a processor associated with the password-protected device.

22. The electronic hardware component of claim 21, wherein the processor is operably coupled to memory containing instructions executable by the processor to cause the electronic hardware component to function in response to receipt of input associated with initialization and/or authentication of a password.
